(19) United States
(12) Patent Application Publication
(10) Pub. No.: US 2025/0067045 A1
(43) Pub. Date: Feb. 27, 2025

(54) MULTIWALL SHEET INCLUDING AN ACOUSTIC RESONATOR

(71) Applicant: SABIC GLOBAL TECHNOLOGIES B.V., Bergen op Zoom (NL)

(72) Inventors: Raj CN Thiagarajan, Bangalore (IN); Christianus Johannes Jacobus Maas, Rilland (NL); Eric Gervais, Maisons Alfort (FR); Peter van den Bleek, Bergen op Zoom (NL)

(21) Appl. No.: 18/720,743

(22) PCT Filed: Dec. 19, 2022
(86) PCT No.: PCT/IB2022/062487

§ 371 Date: Jun. 17, 2024

(30) Foreign Application Priority Data
Dec. 21, 2021 (IN) 202141059609
Feb. 11, 2022 (EP) 22156260.6
Jun. 24, 2022 (EP) 22180939.5

(51) Int. Cl. E04B 1/84

(52) U.S. Cl. CPC E04B 1/8409

(57) ABSTRACT

A multiwall sheet, comprising: walls extending along a z-axis and extending along an x-axis, wherein the x-axis is orthogonal to the z-axis, wherein the walls comprise plastic, and wherein the walls comprise an upper wall (2), and a lower wall (4), wherein the lower wall (4) is spaced apart from the upper wall (2) along a y-axis, and wherein the y-axis is orthogonal to the z-axis and the x-axis; ribs extending along the z-axis and extending along the y-axis between the upper wall (2) and the lower wall (4), wherein the ribs comprise plastic, and wherein the ribs comprise a first rib (6), and a second rib (8), wherein the second rib (8) is spaced apart from the first rib (6) along the x-axis, and wherein the upper wall (2), the lower wall (4), the first rib (6), and the second rib (8) define a cavity (10) having a width Xcavity and a height Ycavity; and an acoustic resonator (100) in the cavity (10), wherein the acoustic resonator (100) extends along the z-axis, comprises plastic, and comprises a first portion (110) extending in a negative y-axis direction from the upper wall (2) into the cavity (10), a second portion (120) extending in a positive x-axis direction from the first portion (110), and a third portion (130) extending in a positive y-axis direction from the second portion (120).

### CROSS REFERENCE TO RELATED APPLICATIONS

This application claims priority to Indian Application 202141059609, filed on Dec. 21, 2021, European Application 22156260.6, filed on Feb. 11, 2022, and European Application 22180939.5, filed on Jun. 24, 2022, the content of which are incorporated by reference in their entirety.

Disclosed herein are multiwall sheets, and more particularly sound insulated multiwall sheets, e.g., for use in glazing and industrial applications.

### BACKGROUND

In the construction of naturally lit structures (e.g., greenhouses, pool enclosures, conservatories, stadiums, sunrooms, and so forth), glass has been employed in many applications as transparent structural elements, such as, windows, facings, and roofs. However, polymer sheeting is replacing glass in many applications due to several notable benefits.

One benefit of polymer sheeting is that it exhibits excellent impact resistance compared to glass. This in turn reduces breakage and hence, maintenance costs in applications wherein vandalism, hail, contraction/expansion, and so forth, is encountered. Another benefit of polymer sheeting is a significant reduction in weight compared to glass. This makes polymer sheeting easier to install than glass and reduces the load-bearing requirements of the structure on which they are installed.

In addition to these benefits, one of the most significant advantages of polymer sheeting is that it provides improved insulative properties compared to glass. This characteristic significantly affects the overall market acceptance of polymer sheeting as consumers desire structural elements with improved efficiency to reduce heating and/or cooling costs. Although the insulative properties of polymer sheeting are greater than that of glass, it is challenging to have a low thermal insulation value, high stiffness (i.e., rigidity), and light transmission in polymer sheeting. Thus, there is a continuous demand for further improvement.

Multiwall sheets are commonly designed for structural and thermal insulation applications. As mentioned, higher thermal insulation values are continually sought in the industry for multiwall sheet applications. Sound pollution is another concern with effective materials for cost effective sound insulation being needed. Increasing the weight of the multiwall sheet is a possibility for increasing sound insulation. However, such an increase in weight is counterproductive to the weight savings utilized by using polymer sheeting compared to glass and adds to the overall cost of the sheeting. Additionally, for applications in which a transparent multiwall sheet is desired, it can be difficult to achieve the desired sound insulation properties of the multiwall sheet without also including the transparency of the multiwall sheet.

Thus, there is a need for multiwall sheets that possess increased sound insulation without a significant increase in weight. There is also a need for increased sound insulation properties without minimal or no impact on the overall transparency of the multiwall sheet. Additionally, multiwall sheets that can be produced with increased sound insulation properties without an increase in manufacturing steps and thus cost, are also desired.

### SUMMARY

Disclosed, in various embodiments, are multiwall sheets and methods for making and using the same.

In an embodiment, a multiwall sheet includes walls extending along a z-axis and extending along an x-axis, wherein the x-axis is orthogonal to the z-axis, wherein the walls include plastic, and wherein the walls include an upper wall (2), and a lower wall (4), wherein the lower wall (4) is spaced apart from the upper wall (2) along a y-axis, and wherein the y-axis is orthogonal to the z-axis and the x-axis; ribs extending along the z-axis and extending along the y-axis between the upper wall (2) and the lower wall (4), wherein the ribs include plastic, and wherein the ribs include a first rib (6), and a second rib (8), wherein the second rib (8) is spaced apart from the first rib (6) along the x-axis, and wherein the upper wall (2), the lower wall (4), the first rib (6), and the second rib (8) define a cavity (10) having a width xcavity and a height ycavity; and an acoustic resonator (100) in the cavity (10), wherein the acoustic resonator (100) extends along the z-axis, includes plastic, and includes a first portion (110) extending in a negative y-axis direction from the upper wall (2) into the cavity (10), a second portion (120) extending in a positive x-axis direction from the first portion (110), and a third portion (130) extending in a positive y-axis direction from the second portion (120).

These and other features and characteristics are more particularly described below.

### BRIEF DESCRIPTION OF THE DRAWINGS

The following is a brief description of the drawings wherein like elements are numbered alike and which are presented for the purposes of illustrating the exemplary embodiments disclosed herein and not for the purposes of limiting the same.

A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure.

FIG. 1 is a partial, cross-sectional view of a multiwall sheet;

FIG. 2 is a partial, cross-sectional view of a multiwall sheet including an acoustic resonator within cavities of the multiwall sheet;

FIG. 3 is a graph of Transmission loss (decibels (dB)) and Sound Transmission Loss (STL) (dB) versus Frequency (hertz (Hz)) of Example 1;

FIG. 4 is a partial, cross-sectional view of a multiwall sheet including an acoustic resonator within cavities of the multiwall sheet;

FIG. 5 is a partial, cross-sectional view of a multiwall sheet including an acoustic resonator within cavities of the multiwall sheet;

FIG. 6 is a partial, cross-sectional view of an embodiment of a multiwall sheet including an acoustic resonator within cavities of the multiwall sheet;

FIG. 7 is a graph of Transmission loss (dB) and STL (dB) versus Frequency (Hz) of Example 2;

FIG. 8 is a partial, cross-sectional view of an embodiment of a multiwall sheet including two acoustic resonators within cavities of the multiwall sheet;

FIG. 9 is a graph of Transmission loss (dB) and STL (dB) versus Frequency (Hz) of Example 3;

FIG. 10 is a partial, cross-sectional view of an embodiment of a multiwall sheet including two acoustic resonators within cavities of the multiwall sheet;

FIG. 11 is a graph of Transmission loss (dB) and STL (dB) versus Frequency (Hz) of Example 4;

FIG. 12 is a partial, cross-sectional view of an embodiment of a multiwall sheet including two acoustic resonators within cavities of the multiwall sheet;

FIG. 13 is a partial, cross-sectional view of an embodiment of a multiwall sheet including two acoustic resonators within cavities of the multiwall sheet;

FIG. 14 is a partial, cross-sectional view of an embodiment of a multiwall sheet including two acoustic resonators within cavities of the multiwall sheet; and

FIG. 15 is a partial, cross-sectional view of an embodiment of a multiwall sheet including two acoustic resonators within cavities of the multiwall sheet.

### DETAILED DESCRIPTION

Disclosed herein are multiwall sheets and methods of making the same in which various cavities of the multiwall sheets include an acoustic resonator. Multiwall sheets including the disclosed acoustic resonator display a surprisingly higher sound transmission loss as compared to multiwall sheets not including the disclosed acoustic resonator. Sound pollution is a key concern in certain applications and thus, multiwall sheets with improved sound transmission losses are needed for sound insulation. A one or two decibel (dB) increase in the sound transmission loss can be considered a significant improvement. The multiwall sheets disclosed herein can provide a greater than or equal to 5 dB increase in the sound transmission loss, for example, greater than or equal to 10 dB or greater than or equal to 15 dB increase in the sound transmission loss at lower weight.

Sound reduction can be achieved either by sound transmission loss or sound attenuation or sound absorption. Without wishing to be bound by theory, it is believed that sound absorption can operate by interacting with the incident sound waves and is mainly a surface interaction phenomenon. Sound is not absorbed effectively with materials such as fiberglass, cellulose, foam, and mineral wool. However, when an acoustic resonator as herein described are used to achieve sound reduction in multiwall sheets, there is an effective reduction in sound.

Sound insulation or STL is a function of the mass, stiffness, and thickness of a multiwall sheet. STL is quantified by a single number rating such as Sound Transmission Class (STC) or Weighted Sound Reduction Index (Rw). STC is a single number rating specified by ASTM E413, for the frequency range of 125 to 4,000 Hz. Rw is single figure rating specified by ISO 717 and DIN 52210-75, for frequency range of 100 to 3,150 Hz. STC and Rw ratings may be the same or within 1 point, and can be used interchangeably. As used herein, STL can denote both STC and Rw.

The STL/STC/Rw of an acoustic product is determined by comparing a measured or calculated transmission loss curve of the acoustic product with a set of ASTM/ISO standard curves. A standard curve is determined that meets the criteria that the sum of the deviations of the standard and measured/calculated curves is not greater than 32 dB, and according to ISO, deviation at any frequency is not more than 8 dB. The value at 500 Hz of the standard curve that meets the criteria is the single-number quantity STL/STC/Rw rating.

The multiwall sheets disclosed herein can offer at least a greater than or equal to 125% improvement, for example, greater than or equal to 150% improvement or greater than or equal to 160% improvement, in the specific STL value for a given sheet, compared to a multiwall sheet having the same material composition and structure but without the acoustic resonator, wherein the specific STL value is measured based upon the sound transmission performance for a square meter area of a multiwall sheet for a given weight of the multiwall sheet wherein the weight of the multiwall sheet is measured in kilograms per square meter (kg/m2).

STL can be a function of mass, stiffness, and acoustic damping. The multiwall sheets disclosed herein offer a system which provides efficient damping and sound insulation. The multiwall sheets disclosed herein can have a higher structural performance index as compared to an equivalent thickness solid sheet and can also provide greater sound insulating capabilities as compared to a multiwall sheet not including the acoustic resonator. It is believed that the acoustic resonator resonates and dissipates the sound energy within the multiwall sheet thereby providing an exceptional sound transmission loss as specified by ASTM E413. Without wishing to be bound by theory, it is believed that the “unequal U” or “unequal leg” of the acoustic resonator can effectively resonate and dissipate the sound energy in the broad frequency range from 100 to 4,000 Hz.

The multiwall sheet can be formed from a plastic material, such as thermoplastic resins, thermosets, or a combination thereof. Possible thermoplastic resins that can be employed to form the multiwall sheet include, but are not limited to, oligomers, polymers, ionomers, dendrimers, copolymers such as graft copolymers, block copolymers (e.g., star block copolymers, random copolymers, etc.), or a combination thereof. Examples of such thermoplastic resins include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends), polyimides (e.g., polyetherimides), acrylonitrile-styrene-butadiene (ABS), polyalkylmethacrylates (e.g., polymethylmethacrylates), polyesters (e.g., copolyesters, polythioesters), polyolefins (e.g., polypropylenes and polyethylenes, high density polyethylenes, low density polyethylenes, linear low density polyethylenes), polyamides (e.g., polyamideimides), polyarylates, polysulfones (e.g., polyarylsulfones, polysulfonamides), polyphenylene sulfides, polytetrafluoroethylenes, polyethers (e.g., polyether ketones, polyether etherketones, polyethersulfones), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazzanes, polysiloxanes, or a combination thereof.

In an embodiment, the plastic used in the multiwall sheet can include, but is not limited to, polycarbonate resins (e.g., Lexan* resins, commercially available from SABIC Innovative Plastics), polyphenylene ether-polystyrene resins (e.g., Noryl* resins, commercially available from SABIC Innovative Plastics), polyetherimide resins (e.g., Ultem* resins, commercially available from SABIC Innovative Plastics), polybutylene terephthalate-polycarbonate resins (e.g., Xenoy* resins, commercially available from SABIC Innovative Plastics), copolyestercarbonate resins (e.g. Lexan* SLX resins, commercially available from SABIC Innovative Plastics), or a combination thereof. In an embodiment, the thermoplastic resins can include, but are not limited to, homopolymers and copolymers of a polycarbonate, a polyester, a polyacrylate, a polyamide, a polyetherimide, a polyphenylene ether, or a combination thereof. The polycarbonate can include copolymers of polycarbonate (e.g., polycarbonate-polysiloxane, such as polycarbonate-polysiloxane block copolymer), linear polycarbonate, branched polycarbonate, end-capped polycarbonate (e.g., nitrile end-capped polycarbonate), or a combination thereof, for example, a combination of branched and linear polycarbonate.

The multiwall sheet can include various additives ordinarily incorporated into polymer compositions of this type, with the proviso that the additive(s) are selected so as to not significantly adversely affect the desired properties of the multiwall sheet, in particular, sound transmission loss and desired degree of transparency. Such additives can be mixed at a suitable time during the mixing of the components for forming the multiwall sheet. Exemplary additives include impact modifiers, fillers, reinforcing agents, antioxidants, heat stabilizers, light stabilizers, ultraviolet (UV) light stabilizers, plasticizers, lubricants, mold release agents, antistatic agents, colorants (such as carbon black and organic dyes), surface effect additives, radiation stabilizers (e.g., infrared absorbing), flame retardants, diffusion barriers (e.g., gas and/or liquid barriers), and anti-drip agents. A combination of additives can be used, for example a combination of a heat stabilizer, mold release agent, and ultraviolet light stabilizer. The additives can be used in the amounts effective for providing the desired property (e.g., UV light stabilizers are effective for filtering UV and protecting the multiwall sheet from UV light). The total amount of additives (other than any impact modifier, filler, or reinforcing agents) can be 0.001 wt % to 5 wt %, based on the total weight of the composition of the multiwall sheet.

In addition to sound transmission, the plastic material can be chosen to exhibit sufficient impact resistance such that the multiwall sheet is capable of resisting breakage (e.g., cracking, fracture, and the like) caused by impact (e.g., hail, birds, stones and so forth). Therefore, plastics exhibiting an impact strength greater than or equal to about 7.5 foot-pounds per square inch (ft-lb/in2) (4.00 Joules per square centimeter (J/cm2)), for example, greater than about 10.0 ft-lb/in2 (5.34 J/cm2) or greater than or equal to about 12.5 ft-lb/in2 (6.67 J/cm2) are desirable, as tested per ASTM D-256-93 (Izod Notched Impact Test). Further, desirably, the plastic has ample stiffness to allow for the production of a multiwall sheet that can be employed in applications wherein the multiwall sheet can be supported and/or clamped on two or more sides of the multiwall sheet (e.g., clamped on all four sides), such as in greenhouse applications including tubular steel frame construction. Sufficient stiffness herein is defined as polymers having a Young's modulus (e.g., modulus of elasticity) that is greater than or equal to about 1×109 Newtons per square meter (N/m2), for example 1×109 to 20×109 N/m2 or 2×109 to 10×109 N/m2.

The acoustic resonator can include any suitable material that will provide the desired sound insulating properties, e.g., the acoustic resonator can include a material as described herein for the multiwall sheet. In an embodiment, a material of the acoustic resonator is the same as a material of the multiwall sheet. In an embodiment, a material of the acoustic resonator is different than a material of the multiwall sheet. When more than one acoustic resonator is present, a material of each of the acoustic resonators can independently be the same as a material of the multiwall sheet, different than a material of the multiwall sheet, the same as a material of other acoustic resonators, different than a material of other acoustic resonators, or a combination thereof.

Polycarbonate, a material that can be used to make the multiwall sheet (e.g., the walls, ribs, or a combination thereof of the multiwall sheet), the acoustic resonator, or a combination thereof, can have a longitudinal velocity of sound of 2,300 meters per second (m/s), a shear wave sound velocity value of 1,250 m/s, and an acoustic impedance value of 2.75 megaRayleighs (MRayl), where one Rayleigh is equivalent to 1 kilogram per square meter second (kg/m2s). Air has a longitudinal velocity of sound of 334 m/s. Thermoplastic resins can have a longitudinal velocity of sound of 1,600 m/s to 2,800 m/s; a shear wave sound velocity of 500 m/s to 1,600 m/s; and an acoustic impedance value of 1.5 MRayl to 3 MRayl. Liquids can have a longitudinal velocity of sound of 750 m/s to 1,500 m/s and an acoustic impedance of 0.8 MRayl to 1.5 MRayl.

A multiwall sheet that does not include the acoustic resonator can be transparent (e.g., the multiwall sheet can have greater than or equal to 95% light transmission). Transparency of a multiwall sheet including acoustic resonator can be less than the transparency of a multiwall sheet that does not include the acoustic resonator. For example, a multiwall sheet that does not include the acoustic resonator can have a transparency of greater than or equal to 85%, for example, greater than or equal to 90%, greater than or equal to 95%, greater than or equal to 96%, or greater than or equal to 99%.

Percent transmission for laboratory scale samples can be determined using ASTM D1003-00, procedure B using CIE standard illuminant C. ASTM D-1003-00 (Procedure B, Spectrophotometer, using illuminant C with diffuse illumination with unidirectional viewing) defines transmittance as:

$$\% T = ( \frac{I}{{I}_{O}} ) \times 100 \% \qquad ( 2 )$$

wherein: I=intensity of the light passing through the test sample
   I₀=Intensity of incident light.

A multiwall sheet can be formed from various polymer processing methods, such as extrusion or injection molding, if produced as a unitary structure. Continuous production methods, such as extrusion, can offer improved operating efficiencies and greater production rates than non-continuous operations, such as injection molding. A single screw extruder can be employed to extrude a polymer melt (e.g., polycarbonate, such as Lexan*, commercially available from SABIC Innovative Plastics). The polymer melt is fed to a profile die capable of forming an extrudate having a cross-section of the multiwall sheet as disclosed and illustrated herein. The multiwall sheet travels through a sizing apparatus (e.g., vacuum bath including sizing dies) and is then cooled below its glass transition temperature (e.g., for polycarbonate, about 297° F. (147° C.)).

After the panel has cooled, it can be cut to the desired length utilizing an extrusion cutter, such as an indexing in-line saw. Once cut, the multiwall sheet can be subjected to secondary operations before packaging. Exemplary secondary operations can include annealing, printing, attachment of fastening members, trimming, further assembly operations, and/or other desirable processes. The size of the extruder, as measured by the diameter of the screw of the extruder, is based upon the production rate desired and calculated from the volumetric production rate of the extruder and the cross-sectional area of the panel. The cooling apparatus can be sized (e.g., length) to remove heat from the extrudate in an expeditious manner without imparting haze.

Haze can be imparted when a polymer (e.g., polycarbonate) is cooled rapidly. Therefore, the cooling apparatus can operate at warmer temperatures (e.g., greater than or equal to about 100° F. (39° C.), for example, greater than or equal to 125° F. (52° C.), rather than colder temperatures (e.g., less than 100° F. (39° C.), for example, less than or equal to about 75° F. (24° C.)) to reduce hazing. If warmer temperatures are employed, the bath length can be increased to allow ample time to reduce the temperature of the extrudate below its glass transition temperature. The size of the extruder, cooling capacity of the cooling apparatus, and cutting operation can be capable of producing the multiwall sheet at a rate of greater than or equal to 5 feet per minute (ft/min) (1.5 meters per minute (m/min)). However, production rates of greater than 10 ft/min (3 m/min), or greater than 15 ft/min (4.6 m/min) can be achieved if such rates are capable of producing surface features that include the desired attributes.

Co-extrusion methods can also be employed for the production of the multiwall sheet. Co-extrusion can be employed to supply different polymers to a portion of the geometry of the multiwall sheet to improve and/or alter the performance of the multiwall sheet and/or to reduce raw material costs. One skilled in the art would readily understand the versatility of the process and the myriad of applications in which co-extrusion can be employed in the production of multiwall sheets.

In an embodiment, a method of sound insulating a structure can include forming a multiwall sheet including an acoustic resonator as described herein and attaching the multiwall sheet to the structure. Formation of the acoustic resonator can be determined based on a degree of sound insulation desired in an area of the structure.

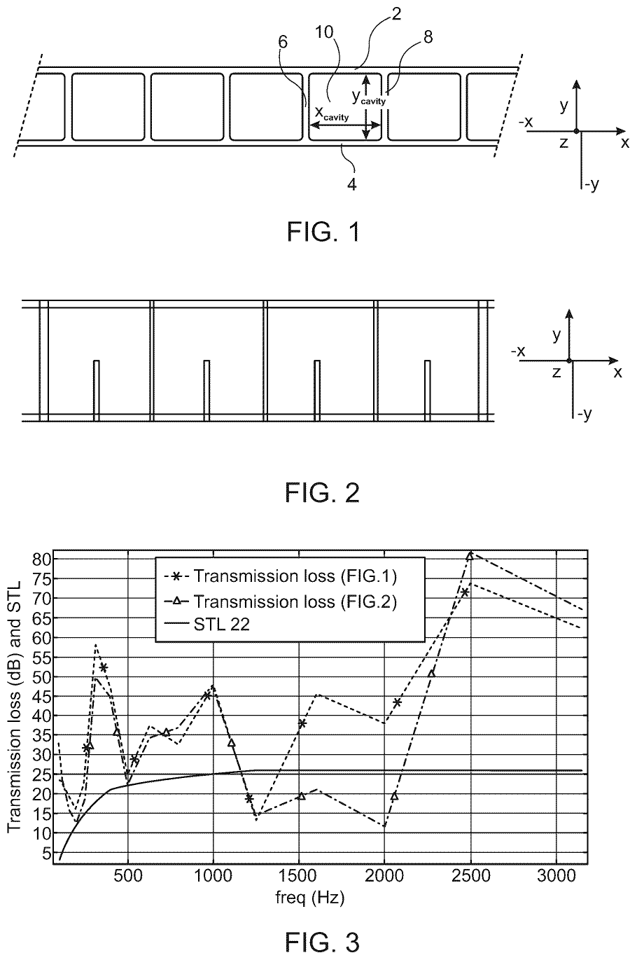

FIG. 1 illustrates a multiwall sheet including walls that extend along a z-axis and extend along an x-axis, which is orthogonal to the z-axis. The walls include an upper wall 2 and a lower wall 4. The upper wall 2 and the lower wall 4 are the outermost walls of the multiwall sheet (also referred to herein as the “skin” of the multiwall sheet). The lower wall 4 is spaced apart from the upper wall 2 along a y-axis, which is orthogonal to the z-axis and the x-axis. The multiwall sheet further includes ribs extending along the z-axis and extending along the y-axis between the upper wall 2 and the lower wall 4. The ribs include a first rib 6 and a second rib 8, which is spaced apart from the first rib 6 along the x-axis. The upper wall 2, the lower wall 4, the first rib 6, and the second rib 8 define a cavity 10 having a width xcavity and a height ycavity.

FIG. 2 is a partial, cross-sectional view of a multiwall sheet including an acoustic resonator 15 within cavities of the multiwall sheet. The acoustic resonators 15 extend along the z-axis and extend in a positive y-axis direction from a lower wall into cavities of the multiwall sheet. Transmission loss for the multiwall sheets illustrated in FIG. 1 and FIG. 2 and STL for the multiwall sheets illustrated in FIG. 1 are provided in Example 1 and FIG. 3.

As used herein, the acoustic resonator being “within cavities” or “in the cavity” of the multiwall sheet means that the acoustic resonator does not contact the ribs or wall defining the cavity other than the wall from which the acoustic resonator extends. With reference to FIGS. 1 and 6, a height (ycavity) of a cavity 10 is greater than a length (y1) of a first portion 110 of an acoustic resonator 100 extending from an upper wall 2 of a multiwall sheet in a negative y-axis direction.

As used herein, the phrases (positive or negative) “x-axis direction,” (positive or negative) “y-axis direction,” and (positive or negative) “z-axis direction,” mean in a direction generally defined by the (positive or negative) x-axis, (positive or negative) y-axis, or (positive or negative) z-axis, respectively. For example, with reference to FIG. 6, angle α formed by a first portion 110 of an acoustic resonator 100 extending from an upper wall 2 of a multiwall sheet in a negative y-axis direction is greater than 450 and less than 135°, for example, greater than 55° and less than 125°, greater than 65° and less than 115°, greater than 75° and less than 105°, greater than 80° and less than 100°, greater than 85° and less than 95°, or 90°. In contrast, angle α formed by the first portion 110 extending from the upper wall 2 in a negative x-axis direction would be greater than 135° and angle α formed by the first portion 110 extending from the upper wall 2 in a positive x-axis direction would be less than 45°.

With regard to the acoustic resonator extending along the z-axis, the acoustic resonator can extend linearly in the (positive or negative) z-axis direction (e.g., the acoustic resonator can be linear in the (positive or negative) z-axis direction) or the acoustic resonator can extend non-linearly in the (positive or negative) z-axis direction (e.g., the acoustic resonator can be non-linear in the (positive or negative) z-axis direction). An acoustic resonator extending linearly in the (positive or negative) z-axis direction (e.g., the acoustic resonator being linear in the (positive or negative) z-axis direction) can ease or improve manufacturability thereof, for example, by extrusion.

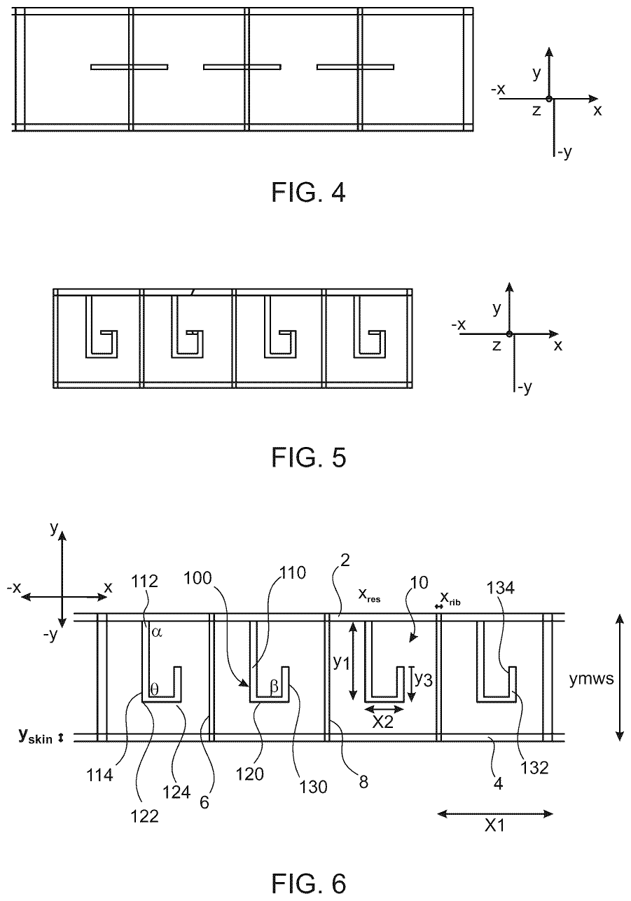

FIG. 4 is a partial, cross-sectional view of a multiwall sheet including an acoustic resonator within cavities of the multiwall sheet. The acoustic resonators extend along the z-axis and extend in a positive and negative y-axis directions from ribs into cavities of the multiwall sheet.

FIG. 5 is a partial, cross-sectional view of a multiwall sheet including an acoustic resonator within cavities of the multiwall sheet. The acoustic resonators extend along the z-axis and include a first portion extending in a negative y-axis direction from an upper wall into cavities of the multiwall sheet, a second portion extending in a positive x-axis direction from the first portion, a third portion extending in a positive y-axis direction from the second portion, and a fourth portion extending from an end of the third portion that is distal to the second portion.

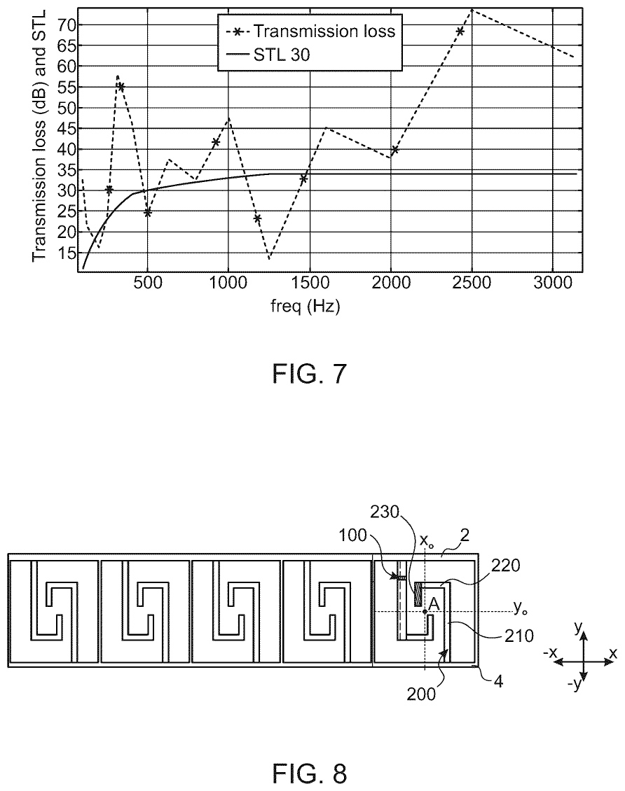

FIG. 6 is a partial, cross-sectional view of an embodiment of a multiwall sheet including an acoustic resonator within cavities of the multiwall sheet. The acoustic resonator 100 extends along the z-axis and includes a first portion 110 extending in a negative y-axis direction from the upper wall 2 into the cavity 10, a second portion 120 extending in a positive x-axis direction from the first portion 110, and a third portion 130 extending in a positive y-axis direction from the second portion 120. Non-limiting examples of transmission loss and STL for the multiwall sheet illustrated in FIG. 6 are provided in Example 2 and FIG. 7.

As compared to the acoustic resonator illustrated in FIG. 5, for the acoustic resonator illustrated in FIG. 6, an end 134 of the third portion 130 (of the acoustic resonator 100) that is distal to the second portion 120 of the acoustic resonator 100 corresponds to, e.g., is, an end of the acoustic resonator 100. Stated otherwise, in an embodiment, the acoustic resonator 100 consists of the first portion 110, the second portion 120, and the third portion 130, or the acoustic resonator 100 does not include a fourth portion that extends from the end 134 of the third portion 130 (of the acoustic resonator 100) that is distal to the second portion 120 (of the acoustic resonator 100).

A total thickness/gauge (also referred to herein as yMWS) of the multiwall sheet measured in the (positive or negative) y-axis direction can be 5 to 150 millimeters (mm), for example, 10 to 100 mm or 10 to 60 mm. A thickness of the skin (also referred to herein as yskin) of the multiwall sheet measured in the (positive or negative) y-axis direction can be 0.1 to 10 mm, for example, 0.1 to 5 mm, 0.15 to 3 mm, or 0.2 to 2 mm. A thickness of the ribs (also referred to herein as xrib) of the multiwall sheet measured in the (positive or negative) x-axis direction can be 0.1 to 10 mm, for example, 0.1 to 5 mm, 0.15 to 3 mm, or 0.2 to 2 mm. For a given cavity, the width xcavity plus thicknesses of the ribs (xrib) forming the cavity (sum referred to herein as x1) in the multiwall sheet measured in the (positive or negative) x-axis direction can be 5 to 150 mm, for example, 10 to 50 or 16 to 32 mm. A thickness of the acoustic resonator (also referred to herein as xᵣs) (measured in the (positive or negative) x-axis direction for the first portion and third portion and measured in the (positive or negative) y-axis direction for the second portion) can be range 0.1 to 10 mm, for example, 0.1 to 5 mm, 0.15 to 3 mm, or 0.2 to 2 mm.

The width of the multiwall sheet measured in the (positive or negative) z-axis direction can provide sufficient spatial area coverage for the intended use (e.g., as a roofing, sheeting, or similar products). The length of the multiwall sheet measured in the (positive or negative) x-axis direction can provide sufficient stiffness for the intended use (e.g., as a roofing, sheeting product, or similar product).

A ratio of a length of the first portion 110 of the acoustic resonator 100 (also referred to herein as y1) measured in the (positive or negative) y-axis direction to yMWS (i.e., y1:yMWS) can be 0.1:1 to 0.99:1, for example, 0.5:1 to 0.6:1. A ratio of a length of the third portion 130 of the acoustic resonator 100 (also referred to herein as y3) measured in the (positive or negative) y-axis direction to y1 (i.e., y3:y1) can be 0.1:1 to 0.99:1, for example, 0.5:1 to 0.6:1. A ratio of a length of the second portion 120 of the acoustic resonator 100 (also referred to herein as x2) measured in the (positive or negative) x-axis direction to x1 (i.e., x2:x1) can be 0.1:1 to 0.99:1, for example, 0.2:1 to 0.3:1.

The first portion 110 can extend from the upper wall 2 forming an angle α, for example, 80 to 110°. The second portion 120 can extend from an end 114 of the first portion 110 that is distal to the upper wall 2. The second portion 120 can extend from the first portion 110 forming an angle θ, for example, 80 to 110°. The third portion 130 can extend from at an end 124 of the second portion 120 that is distal to the first portion 110. The third portion 130 can extend from the second portion 120 forming an angle β, for example, 80 to 110°. In an embodiment, a second linear portion of the acoustic resonator extends from a first linear portion of the acoustic resonator forming an angle of 80 to 110°, a third linear portion of the acoustic resonator extends from the second linear portion of the acoustic resonator forming an angle of 80 to 110°, or a combination thereof (e.g., each linear portion of the acoustic resonator extends from another linear portion of the acoustic resonator forming an angle of 80 to 110°). The second linear portion of the acoustic resonator extending from the first linear portion of the acoustic resonator forming an angle of 80 to 110°, the third linear portion of the acoustic resonator extending from the second linear portion of the acoustic resonator forming an angle of 80 to 110°, or the combination thereof (e.g., each linear portion of the acoustic resonator extending from another linear portion of the acoustic resonator forming an angle of 80 to 110°), can ease or improve manufacturability of the acoustic resonator.

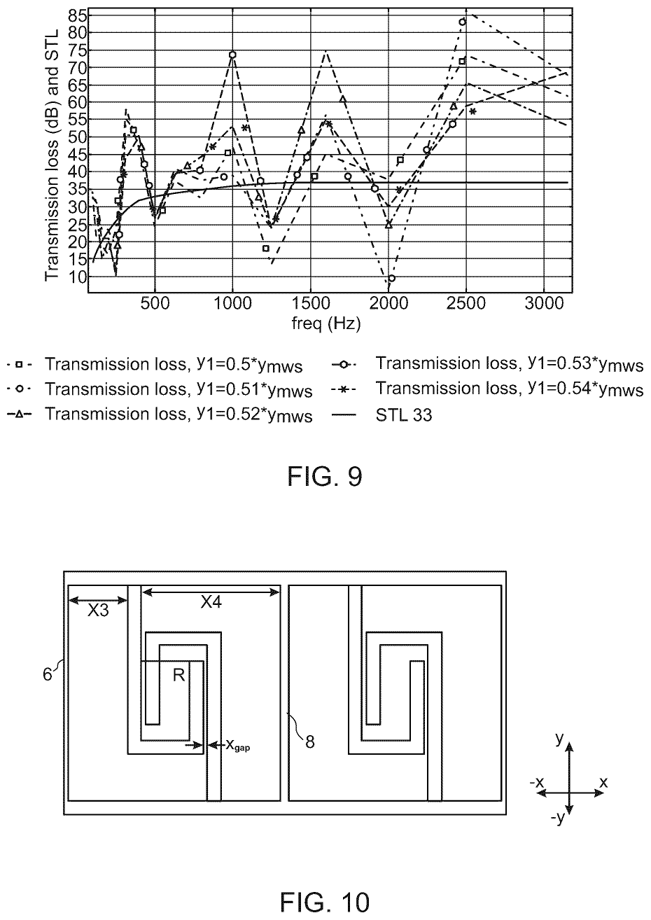

FIG. 8 is a partial, cross-sectional view of an embodiment of a multiwall sheet including two acoustic resonators within cavities of the multiwall sheet. In an embodiment, the second acoustic resonator 200 includes plastic. The second acoustic resonator 200 can be rotationally symmetrical to the acoustic resonator 100 around a point A in the center of the cavity 10 and can extend from the lower wall 4. The second acoustic resonator 200 can include a portion I 210 extending in the positive y-axis direction from the lower wall 4 into the cavity 10, a portion II 220 extending in a negative x-axis direction from the portion I 210, and a portion III 230 extending in the negative y-axis direction from the portion II 220. Non-limiting examples of transmission loss and STL for the multiwall sheet illustrated in FIG. 8 are provided in Example 3 and FIG. 9.

In an embodiment, the first portion 110 of the acoustic resonator 100 is located on a first side of a center line x0 along the width xcavity of the of the cavity 10. The portion I 210 of the second acoustic resonator 200 can be located on a second side of the center line x0. The second portion 120 of the acoustic resonator 100 can extend from the first portion 110 of the acoustic resonator 100 to the second side of the center line x0. The portion II 220 of the second acoustic resonator 200 can extend from the portion I (210) of the second acoustic resonator 200 to the first side of the center line x0.

In an embodiment, the upper wall 2 is located on a first side of a center line y0 along the height ycavity of the cavity 10. The lower wall 4 can be located on a second side of the center line y0. The first portion 110 of the acoustic resonator 100 can extend from the upper wall 2 to the second side of the center line y0. The portion I 210 of the second acoustic resonator 200 can extend from the lower wall 4 to the first side of the center line y0.

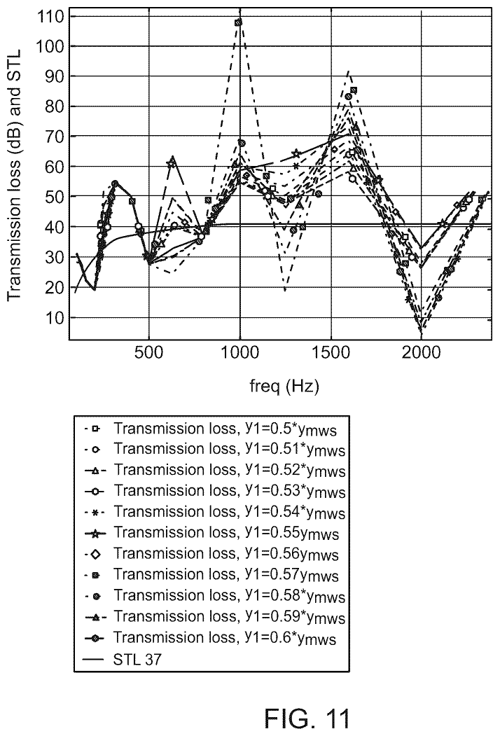

FIG. 10 is a partial, cross-sectional view of an embodiment of a multiwall sheet including two acoustic resonators within cavities of the multiwall sheet. As illustrated in FIG. 10, the first portion 110, second portion 120, and third portion 130 of the acoustic resonator 100 define a hook region R and an end 234 of the portion III 230 that is distal to the portion II 220 of the second acoustic resonator 200 is located in the hook region R. Non-limiting examples of transmission loss and STL for the multiwall sheet illustrated in FIG. 10 are provided in Example 4 and FIG. 11. [0063]yMWS can be 5 to 150 mm, for example, 10 to 100 mm or 10 to 60 mm; yskin can be 0.1 to 10 mm, for example, 0.1 to 5 mm, 0.15 to 3 mm, or 0.2 to 2 mm; xrib can be 0.1 to 10 mm, for example, 0.1 to 5 mm, 0.15 to 3 mm, or 0.2 to 2 mm; and x1 can be 5 to 150 mm, for example, 10 to 50 mm or 16 to 32 mm.

A distance between the third portion 130 of the acoustic resonator 100 and the portion I 210 of the second acoustic resonator 200 (also referred to herein as xgap) can satisfy the equation 0.1*x1≤xgap≤0.5*x1, for example, xgap can be equal to 0.25* x1. A distance from rib 6 to acoustic resonator 100 (also referred to herein as x3) can satisfy the equation 0.1*x1≤x3≤0.99*x1; for example, x3 can be equal to 0.25*x1. A distance from rib 8 to acoustic resonator 100 (also referred to herein as the x4) can satisfy the equation 0.1*x1≤x4≤0.99*x1; for example, x4 can be equal to 0.75*x1. The second acoustic resonator 200 can be rotationally symmetrical to the acoustic resonator 100 around a point in the center of the cavity 10 and can extend from the lower wall 4.

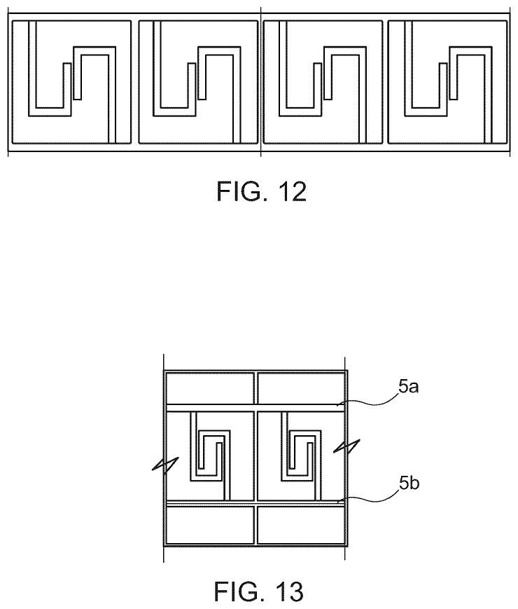

FIG. 12 is a partial, cross-sectional view of an embodiment of a multiwall sheet including two acoustic resonators within cavities of the multiwall sheet. As illustrated in FIG. 12, the first portion 110 of the acoustic resonator 100 is located on a first side of a center line x0 along the width xcavity of the of the cavity 10. The portion I 210 of the second acoustic resonator 200 is located on a second side of the center line x0. The second portion 120 of the acoustic resonator 100 does not extend from the first portion 110 of the acoustic resonator 100 into the second side of the center line x0. The portion II 220 of the second acoustic resonator 200 does not extend from the portion I 210 of the second acoustic resonator 200 into the first side of the center line x0.

FIG. 13 is a partial, cross-sectional view of an embodiment of a multiwall sheet including two acoustic resonators within cavities of the multiwall sheet. As compared to FIG. 10, the multiwall sheet of FIG. 13 further includes transverse walls 5a, 5b. The acoustic resonator 100 and second resonator 200 extend from the transverse wall 5a, 5b, rather than the upper wall 2 and lower wall 4. The cavity 10 is formed by the ribs 6, 8 and the transverse wall 5a, 5b, rather than the ribs 6, 8, the upper wall 2, and lower wall 4. The upper wall 2 and the lower wall 4 remain the outermost walls of the multiwall sheet.

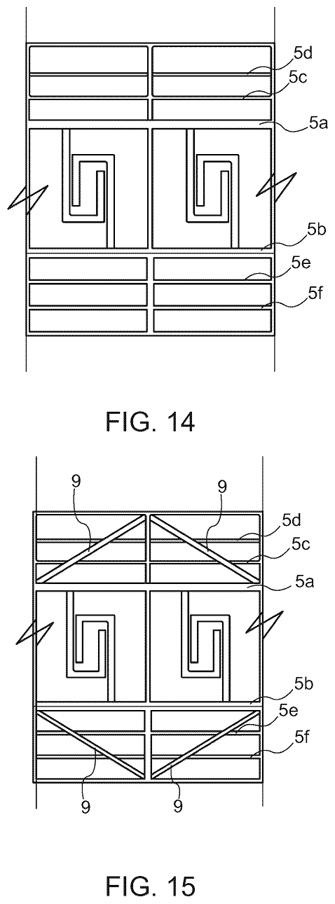

FIG. 14 is a partial, cross-sectional view of an embodiment of a multiwall sheet including two acoustic resonators within cavities of the multiwall sheet. As compared to FIG. 13, the multiwall sheet of FIG. 14 further includes transverse walls 5c, 5d, 5e, 5f. The traverse wall 5c, 5d are located between the traverse wall 5a and the upper wall 2. The traverse wall 5e, 5f are located between the traverse wall 5b and the lower wall 4.

FIG. 15 is a partial, cross-sectional view of an embodiment of a multiwall sheet including two acoustic resonators within cavities of the multiwall sheet. As compared to FIG. 14, the multiwall sheet of FIG. 15 further includes dividers 9, which are located between the traverse wall 5a and the upper wall 2, between the traverse wall 5b and the lower wall 4, or a combination thereof, are non-parallel and non-perpendicular to the walls and the ribs.

With reference to FIG. 13, FIG. 14, and FIG. 15, in an embodiment, the transverse walls can extend longitudinally the length of the upper wall 2 and the lower wall 4 (e.g., extend between upper wall 2 and lower wall 4, but not contact). In an embodiment, the transverse walls can be parallel to the upper wall 2 and the lower wall 4, or the transverse wall can be substantially parallel to the upper wall 2 and the lower wall 4 (e.g., not completely parallel across the entire length of the upper wall 2 and the lower wall 4, but also not intersecting the upper wall 2 or the lower wall 4, accommodating for slight variations in the orientation during processing).

The multiwall sheet can have sinusoidal shaped dividers. It is contemplated that any suitable shape dividers could be used. For example, the dividers can include a shape such as lamellar-shaped elements, triangular-shaped elements, pyramidal-shaped elements, cylindrical-shaped elements, conical-shaped elements, cubical-shaped elements, trapezoidal-shaped elements, sinusoidal-shaped elements, saw tooth-shaped elements, abs(sin)-shaped elements, cycloid-shaped elements, fiber shaped elements, or a combination thereof.

In an embodiment, each cavity of the multiwall sheet includes an, e.g., at least one, acoustic resonator. In an embodiment, some cavities include an, e.g., at least one, acoustic resonator, while others do not include an acoustic resonator. For example, every other cavity can include an, e.g., at least one, acoustic resonator or two adjacent cavities can include an acoustic resonator with empty cavities (e.g., not including an acoustic resonator) on either side of the cavities including an, e.g., at least one, acoustic resonator.

Optionally, the multiwall sheet can additionally include a clip located at an end of the multiwall sheet to facilitate attachment to a structure, frame enclosure for the multiwall sheet, or to another multiwall sheet. The multiwall sheet can, optionally, include a receiving end for a clip to attach thereto.

Different visual effects can be created by using colored acoustic resonators. For example, an acoustic resonators of a first color can be included in a given cavity and an acoustic resonators of a different color can be included in another cavity, creating different visual effects. In an embodiment, some of the multiwall sheet can be transparent (e.g., at least 85% transparent), while a cavity including an acoustic resonators can be opaque or translucent. The sizes, positions, dimensions, or a combination thereof of acoustic resonators can differ between differing cavities.

The multiwall sheet can be tuned such that specific areas of the multiwall sheet can be more sound insulating than others. For example, some cavities can include an acoustic resonator to provide sound insulation over the area covered by the multiwall sheet, while other cavities of the multiwall sheet can be left without an acoustic resonator if sound insulation is not desired or needed in certain areas of the multiwall sheet. By tuning the sound insulation, the desired sound reduction can be attained while minimizing the weight increase.

When assembled, the multiwall sheet can be exposed to a variety of forces caused by snow, wind, rain, hail, and the like. The multiwall sheet is desirably capable of withstanding these forces without failing (e.g., buckling, cracking, bowing, and so forth). The specific dimensions of the multiwall sheet can be chosen so that the multiwall sheet can withstand these forces.

STL can be predicted using numerical prediction of acoustic performance of multiwall sheet using prediction software, e.g., COMSOL Multiphysics software. Sound transmission class can be calculated according to ASTM E413, while the sound reduction index (Rw) can be calculated according to ISO 717-DIN 52210. These standards can be used to rate partitions, doors, windows, and roofs for their effectiveness in blocking sound.

Such a multiwall sheet as disclosed herein can provide an overall best performance and low cost product for sound insulation. The lightweight multiwall sheet is easy to install. The disclosed multiwall sheets including an acoustic resonator can achieve a greater than or equal to 125% improvement, for example, greater than or equal to 150% improvement or greater than or equal to 160% improvement, in specific STL performance. The multiwall sheets disclosed herein can be used in a variety of applications, including, but not limited to, industrial roof and sidewalls, commercial greenhouses, sunroom, swimming pool, and conservatory roofing, shopping center roofing, railway/metro stations, football stadium roofing, and roof lights.

The following examples are merely illustrative of the device disclosed herein and are not intended to limit the scope hereof. All of the following examples were based upon simulations unless specifically stated otherwise.

### EXAMPLES

In the Examples, Sound Transmission Loss (STL)/Sound Transmission Class (STC)/Weighted Sound Reduction Index (Rw) is determined by comparing a simulated transmission loss curve of an acoustic product using COMSOL Multiphysics software with a set of ASTM/ISO standard curves. A standard curve that meets the criteria that the sum of the deviations of the standard and simulated curves is not greater than 32 dB, and according to ISO, deviation at any frequency is not more than 8 dB, is determined. The value at 500 Hz of the standard curve that meets the criteria is the single-number quantity STL/STC/Rw rating.

### Example 1

An STL predicted value of the multiwall sheet illustrated in FIG. 1 was determined. Dimensions of the multiwall sheet illustrated in FIG. 1 included 55 millimeters (mm) yMWS, 50 mm x1, 2 mm yskin, and 2 mm xrib. Dimensions of the multiwall sheet illustrated in FIG. 2 included 55 millimeters (mm) yMWS, 50 mm x1, 2 mm yskin, and 2 mm xrib. FIG. 3 includes an STL predicted value by ASTM/ISO standard (solid line) and STL simulated values using the COMSOL Multiphysics software (dotted lines) for the multiwall sheets. In FIG. 3, for the multiwall sheet illustrated in FIG. 1, the predicted STL predicted value is 22 dB at 500 Hz, the STL simulated value is 23 dB at 500 Hz, and the numerical prediction is within plus or minus 1 dB of the simulated value.

### Example 2

An STL predicted value of the multiwall sheet including an acoustic resonator illustrated in FIG. 6 was determined. Dimensions of the multiwall sheet including an acoustic resonator illustrated in FIG. 6 included 55 millimeters (mm) yMWS, 50 mm x1, 2 mm yskin, 2 mm xrib, 41.25 mm y1, 13.75 mm y3, and 12.5 mm x2. FIG. 7 includes an STL predicted value by ASTM/ISO standard (solid line) and STL simulated values (dotted line) for the multiwall sheet. In FIG. 7, the STL predicted value is 30 dB at 500 Hz.

### Example 3

An STL predicted value of the multiwall sheet including two acoustic resonators illustrated in FIG. 8 was determined. Dimensions of the multiwall sheet including an acoustic resonator illustrated in FIG. 8 included 55 millimeters (mm) yMWS, 50 mm x1, 2 mm yskin, 2 mm xrib, 2 mm xres, 33 mm y3, 15 mm x2, 0.5 mm xgap, and 12.5×3. The value for y1 varied between 0.5*yMWS and 0.54*yMWS as shown in FIG. 9. The second acoustic resonator was rotationally symmetrical to the acoustic resonator around a point in the center of the cavity and extended from the lower wall. FIG. 9 includes an STL predicted value by ASTM/ISO standard (solid line) and STL simulated values (dotted lines) for the multiwall sheets. In FIG. 9, the STL predicted value is 33 dB at 500 Hz.

### Example 4

An STL predicted value of the multiwall sheet including two acoustic resonators illustrated in FIG. 10 was determined. Dimensions of the multiwall sheet including an acoustic resonator illustrated in FIG. 10 included 55 millimeters (mm) yMWS, 50 mm x1, 2 mm yskin, 2 mm xrib, 2 mm xres, 33 mm y1, 33 mm y3, 14.5 mm x2, 0.5 mm xgap, and 12.5×3. The value for y1 varied between 0.5* yMWS and 0.6* yMWS as shown in FIG. 11. The second acoustic resonator was rotationally symmetrical to the acoustic resonator around a point in the center of the cavity and extended from the lower wall. FIG. 11 includes an STL predicted value by ASTM/ISO standard (solid line) and STL simulated values (dotted lines) for the multiwall sheets. In FIG. 11, the STL predicted value is 37 dB at 500 Hz.

In an embodiment, a multiwall sheet comprises: walls extending along a z-axis and extending along an x-axis, wherein the x-axis is orthogonal to the z-axis, wherein the walls comprise plastic, and wherein the walls comprise an upper wall (2), and a lower wall (4), wherein the lower wall (4) is spaced apart from the upper wall (2) along a y-axis, and wherein the y-axis is orthogonal to the z-axis and the x-axis; ribs extending along the z-axis and extending along the y-axis between the upper wall (2) and the lower wall (4), wherein the ribs comprise plastic, and wherein the ribs comprise a first rib (6), and a second rib (8), wherein the second rib (8) is spaced apart from the first rib (6) along the x-axis, and wherein the upper wall (2), the lower wall (4), the first rib (6), and the second rib (8) define a cavity (10) having a width xcavity and a height ycavity; and an acoustic resonator (100) in the cavity (10), wherein the acoustic resonator (100) extends along the z-axis, comprises plastic, and comprises a first portion (110) extending in a negative y-axis direction from the upper wall (2) into the cavity (10), a second portion (120) extending in a positive x-axis direction from the first portion (110), and a third portion (130) extending in a positive y-axis direction from the second portion (120).

### In an Embodiment:

(i) the first portion (110) extends from the upper wall (2) forming an angle α; wherein the angle α is 80 to 110°; the second portion (120) extends from an end (114) of the first portion (110) that is distal to the upper wall (2); and wherein the second portion (120) extends from the first portion (110) forming an angle θ; wherein the angle θ is 80 to 110°; and the third portion (130) extends from at an end (124) of the second portion (120) that is distal to the first portion (110); and wherein the third portion (130) extends from the second portion (120) forming an angle β; wherein the angle β is 80 to 110°;
(ii) the multiwall sheet further comprises a second acoustic resonator (200) in the cavity (10), wherein the second acoustic resonator (200) comprises plastic;
(iii) the second acoustic resonator (200) is rotationally symmetrical to the acoustic resonator (100) around a point A in the center of the cavity (10) and extends from the lower wall (4);
(iv) the second acoustic resonator (200) comprises a portion I (210) extending in the positive y-axis direction from the lower wall (4) into the cavity (10),a portion II (220) extending in a negative x-axis direction from the portion I (210), and a portion III (230) extending in the negative y-axis direction from the portion II (220);
(v) the first portion (110) of the acoustic resonator (100) is located on a first side of a center line x₀ along the width x_{cavity} of the of the cavity (10); the portion I (210) of the second acoustic resonator (200) is located on a second side of the center line x₀; the second portion (120) of the acoustic resonator (100) extends from the first portion (110) of the acoustic resonator (100) to the second side of the center line x₀; and the portion II (220) of the second acoustic resonator (200) extends from the portion I (210) of the second acoustic resonator (200) to the first side of the center line x₀;
(vi) the upper wall (2) is located on a first side of a center line y₀ along the height y_{cavity} of the cavity (10); the lower wall (4) is located on a second side of the center line y₀; the first portion (110) of the acoustic resonator (100) extends from the upper wall (2) to the second side of the center line y₀; and the portion I (210) of the second acoustic resonator (200) extends from the lower wall (4) to the first side of the center line y₀;
(vii) the first portion (110), second portion (120), and third portion (130) of the acoustic resonator (100) define a hook region R; and an end (234) of the portion III (230) that is distal to the portion II (220) of the second acoustic resonator (200) is located in the hook region R; (viii) an end (134) of the third portion (130) that is distal to the second portion (120) of the acoustic resonator (100) comprises an end of the acoustic resonator (100);
(ix) a total thickness of the multiwall sheet measured in the positive y-axis direction is 5 to 150 millimeters, for example, 10 to 100 millimeters or 10 to 60 millimeters;
(x) a ratio of a length of the first portion (110) of the acoustic resonator (100) measured in the positive y-axis direction to the total thickness of the multiwall sheet measured in the positive y-axis direction is 0.1:1 to 0.99:1, for example, 0.5:1 to 0.6:1;
(xi) a thickness of the first portion (110) of the acoustic resonator (100) measured in the positive x-axis direction is range 0.1 to 10 millimeters, for example, 0.1 to 5 millimeters, 0.15 to 3 millimeters, or 0.2 to 2 millimeters;
(xii) a ratio of a length of the third portion (130) of the acoustic resonator (100) measured in the positive y-axis direction to a length of the first portion (110) of the acoustic resonator (100) measured in the positive y-axis direction is 0.1:1 to 0.99:1, for example, 0.5:1 to 0.6:1;
(xiii) a thickness of the ribs measured in the positive x-axis direction is 0.1 to 10 millimeters, for example, 0.1 to 5 millimeters, 0.15 to 3 millimeters, or 0.2 to 2 millimeters; and/or
(xiv) a ratio of (a length of the second portion (120) of the acoustic resonator (100) measured in the (positive or negative) x-axis direction) to (the width x_{cavity} plus the thicknesses of the first rib (6) and the second rib (8)) is 0.1:1 to 0.99:1, for example, 0.2:1 to 0.3:1.

All ranges disclosed herein are inclusive of the endpoints, and the endpoints are independently combinable with each other (e.g., ranges of “up to 25 wt. %, or, for example, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to determine one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “an embodiment” means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The terms “lower”, “upper”, etc. are used herein, unless otherwise noted, merely for convenience of description, and are not limited to any one position or spatial orientation. It will be understood that relative terms are intended to encompass different orientations of the device in addition to the orientation described. For example, if a device is turned over, elements described as being on the “lower” side of other elements would then be oriented on “upper” sides of the other elements. The exemplary term “lower,” can therefore, encompasses both an orientation of “lower” and “upper,” depending on the particular orientation of the figure.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Unless specified to the contrary herein, all test standards are the most recent standard in effect as of the filing date of this application, or, if priority is claimed, the filing date of the earliest priority application in which the test standard appears.

The invention claimed is:

1. A multiwall sheet, comprising:
walls extending along a z-axis and extending along an x-axis, wherein the x-axis is orthogonal to the z-axis, wherein the walls comprise plastic, and wherein the walls comprise
an upper wall (2), and
a lower wall (4),
wherein the lower wall (4) is spaced apart from the upper wall (2) along a y-axis, and
wherein the y-axis is orthogonal to the z-axis and the x-axis;
ribs extending along the z-axis and extending along the y-axis between the upper wall (2) and the lower wall (4), wherein the ribs comprise plastic, and wherein the ribs comprise
a first rib (6), and
a second rib (8),
wherein the second rib (8) is spaced apart from the first rib (6) along the x-axis, and
wherein the upper wall (2), the lower wall (4), the first rib (6), and the second rib (8) define a cavity (10) having a width x_{cavity} and a height y_{cavity}; and
an acoustic resonator (100) in the cavity (10),
wherein the acoustic resonator (100)
extends along the z-axis,
comprises plastic, and
comprises
a first portion (110) extending in a negative y-axis direction from the upper wall (2) into the cavity (10),
a second portion (120) extending in a positive x-axis direction from the first portion (110), and
a third portion (130) extending in a positive y-axis direction from the second portion (120).

2. The multiwall sheet of claim 1, wherein
the first portion (110) extends from the upper wall (2) forming an angle α; wherein the angle α is 80 to 110°;
the second portion (120) extends from an end (114) of the first portion (110) that is distal to the upper wall (2); and wherein the second portion (120) extends from the first portion (110) forming an angle θ; wherein the angle θ is 80 to 110°; and
the third portion (130) extends from at an end (124) of the second portion (120) that is distal to the first portion (110); and wherein the third portion (130) extends from the second portion (120) forming an angle β; wherein the angle β is 80 to 110°.

3. The multiwall sheet of claim 1, further comprising a second acoustic resonator (200) in the cavity (10), wherein the second acoustic resonator (200) comprises plastic.

4. The multiwall sheet of claim 3, wherein the second acoustic resonator (200) is rotationally symmetrical to the acoustic resonator (100) around a point A in the center of the cavity (10) and extends from the lower wall (4).

5. The multiwall sheet of claim 3, wherein the second acoustic resonator (200) comprises
a portion I (210) extending in the positive y-axis direction from the lower wall (4) into the cavity (10),
a portion II (220) extending in a negative x-axis direction from the portion I (210), and
a portion III (230) extending in the negative y-axis direction from the portion II (220).

6. The multiwall sheet of claim 5, wherein
the first portion (110) of the acoustic resonator (100) is located on a first side of a center line x₀ along the width x_{cavity} of the of the cavity (10);
the portion I (210) of the second acoustic resonator (200) is located on a second side of the center line x₀;
the second portion (120) of the acoustic resonator (100) extends from the first portion (110) of the acoustic resonator (100) to the second side of the center line x₀; and
the portion II (220) of the second acoustic resonator (200) extends from the portion I (210) of the second acoustic resonator (200) to the first side of the center line x₀.

7. The multiwall sheet of claim 5, wherein
the upper wall (2) is located on a first side of a center line y₀ along the height y_{cavity} of the cavity (10);
the lower wall (4) is located on a second side of the center line y₀;
the first portion (110) of the acoustic resonator (100) extends from the upper wall (2) to the second side of the center line y₀; and
the portion I (210) of the second acoustic resonator (200) extends from the lower wall (4) to the first side of the center line y₀.

8. The multiwall sheet of claim 5, wherein
the first portion (110), second portion (120), and third portion (130) of the acoustic resonator (100) define a hook region R; and
an end (234) of the portion III (230) that is distal to the portion II (220) of the second acoustic resonator (200) is located in the hook region R.

9. The multiwall sheet of claim 1, wherein an end (134) of the third portion (130) that is distal to the second portion (120) of the acoustic resonator (100) comprises an end of the acoustic resonator (100).

10. The multiwall sheet of claim 1, wherein a total thickness of the multiwall sheet measured in the positive y-axis direction is 5 to 150 millimeters, for example, 10 to 100 millimeters or 10 to 60 millimeters.

11. The multiwall sheet of 10, wherein a ratio of a length of the first portion (110) of the acoustic resonator (100) measured in the positive y-axis direction to the total thickness of the multiwall sheet measured in the positive y-axis direction is 0.1:1 to 0.99:1, for example, 0.5:1 to 0.6:1.

12. The multiwall sheet of claim 1, wherein a thickness of the first portion (110) of the acoustic resonator (100) measured in the positive x-axis direction is range 0.1 to 10 millimeters, for example, 0.1 to 5 millimeters, 0.15 to 3 millimeters, or 0.2 to 2 millimeters.

13. The multiwall sheet of claim 1, wherein a ratio of a length of the third portion (130) of the acoustic resonator (100) measured in the positive y-axis direction to a length of the first portion (110) of the acoustic resonator (100) measured in the positive y-axis direction is 0.1:1 to 0.99:1, for example, 0.5:1 to 0.6:1.

14. The multiwall sheet of claim 1, wherein a thickness of the ribs measured in the positive x-axis direction is 0.1 to 10 millimeters, for example, 0.1 to 5 millimeters, 0.15 to 3 millimeters, or 0.2 to 2 millimeters.

15. The multiwall sheet of 13, wherein a ratio of (a length of the second portion (120) of the acoustic resonator (100) measured in the x-axis direction) to (the width x_{cavity} plus the thicknesses of the first rib (6) and the second rib (8)) is 0.1:1 to 0.99:1, for example, 0.2:1 to 0.3:1.
